(19) United States
(12) Patent Application Publication
(10) Pub. No.: US 2014/0190725 A1
(43) Pub. Date: Jul. 10, 2014

(54) DUAL WALL SLIT-LESS DASHBOARD GROMMET FOR VEHICLES

(71) Applicant: FORD GLOBAL TECHNOLOGIES, LLC, Dearborn, MI (US)

(72) Inventor: Mohammed Michael BAYDOUN, Dearborn Heights, MI (US)

(73) Assignee: FORD GLOBAL TECHNOLOGIES, LLC, Dearborn, MI (US)

(21) Appl. No.: 13/738,804

(22) Filed: Jan. 10, 2013

(51) Int. Cl. H01B 17/58

(52) U.S. Cl. CPC H01B 17/583
USPC 174/153 G

(57) ABSTRACT

A grommet mounted on an opening through an interface within a vehicle. The interface separates a source side compartment from a receiving side compartment of the vehicle. The grommet has a first portion mounted in the surface of the interface facing the receiving side compartment. The first portion has a hollow channel that projects towards the receiving side compartment and delivers a bunch of wires to the receiving side compartment. The channel has an end that communicates with the source side compartment. A second portion of the grommet is mounted in a surface of the interface facing the source side compartment. The second portion has a pliable tubular member communicating with and leading into the channel of the first portion. The tubular member receives the bunch of wires from the source side compartment and delivers the bunch to the receiving side compartment.

### TECHNICAL FIELD

Embodiments of the present disclosure generally relate to automotive vehicles, and, more specifically, to grommets used for passage of electrical wires through a wall or an interface between different compartments of an automotive vehicle.

### BACKGROUND

Grommets have been widely used in many applications, for safe and smooth passage of wires through sharp edged holes through interfaces, and to protect the passing wires from getting abraded or cut. Specifically, if a metallic interface or an interface composed of a hard material has a hole with sharp edges, the electrical wires/insulation for the wires passing through the hole may get damaged due to repeated flexing at the exit point of the hole. Mounting a grommet in the hole, and allowing the wires to rather pass through the grommet may prevent those wires from being damaged, due to the soft inner portion of the grommet. The grommet is usually composed of rubber, plastic or another appropriate material.

In automotive vehicles, grommets are generally used to allow safe passage of electrical wires through a wall, usually called a panel or interface, from the engine side compartment to the vehicles' cabin compartment. For example, certain wires connecting the vehicle's steering system/audio system to the components within the engine side compartment may require passage through the dashboard of the vehicle. To facilitate this, a hole may be made through the dashboard interface, and a grommet may be mounted in the hole, to let the electrical wires pass through the hole. Specifically, this protects the passing wires from possible damages due to being in contact with the sharp edges of the hole. When used in automotive vehicles, including cars, grommets are generally designed to further meet many other criteria, in addition to protecting the passing wires from damaging. The grommets may also protect the wires from being contaminated due to dirt, air or water. To achieve that, the grommets can be leak proof. Further, there is a possibility that noise may travel from the engine compartment to the cabin compartment of the vehicle, through the hole where the grommet is mounted. Hence, a grommet may be designed to have material proprieties that allow it to substantially absorb sound waves, preventing them from getting transmitted from a source to the occupants' compartment (i.e., the cabin compartment of the vehicle). Also, the connections of the wires at the inlet and exit ports of a grommet should be completely sealed, to avoid noise transmission through the grommet.

In many conventionally used grommets, the port through which the wires pass is hard to seal due to force exerted by the bundle of wires passing through the port. The problem of sealing the port may even worsen if the grommet is mounted on a sheet metal interface, or due to other process limitations. This results in leaky grommet issues, where undesirable noise can easily pass through the interface, along the region where the grommet is mounted.

Further, during the process of servicing the vehicle, whenever a mechanic needs to access the interior of the engine compartment through the cabin compartment of the vehicle, a portion of a grommet may need to be removed to allow access to the engine compartment. For example, in a case where a wiring connection is desired between the vehicle's audio system and the battery located within the interior of the engine compartment of the vehicle, a portion of the grommet may be required to be cut, to create an access port. Cutting the grommet may increase noise transmission through the grommet, and may also destroy the grommet completely in some cases.

Therefore, there exists a need for a grommet mountable in an interface on a front portion of a vehicle, which allows safe passage of electrical wires from the engine compartment to the cabin compartment of the vehicle, and which substantially reduce transmission of undesirable noise from the engine compartment to the cabin compartment, while being mounted on the interface. Further, during the process of servicing the vehicle under any faulty conditions, it would be beneficial if the grommet had portions adapted to allow the passage of additional wires, without a need for cutting the grommet, to avoid undesirable damage to the grommet.

### SUMMARY

The present disclosure provides a dual wall grommet adapted to be mounted in an interface within a portion of a vehicle, for connection and passage of electrical connection wires from an engine compartment to a cabin compartment of the vehicle. The grommet is designed to substantially reduce noise transmitted from the engine side compartment to the cabin side compartment, when being mounted in the interface.

In one aspect, the present disclosure provides a grommet mountable on an opening through an interface within a portion of a vehicle. The interface separates the engine side compartment (acting as a source side compartment) from the cabin compartment (acting as a receiving side compartment) of the vehicle. The grommet includes a first portion mounted over the surface of the interface facing the receiving side compartment. The first portion has a hollow channel which projects towards the receiving side compartment. The channel has a first end, and a second end that communicates with the receiving side compartment. Further, the channel delivers a bunch of electrical wires to the receiving side compartment, and has multiple intruding portions provided on its outer surface. The intruding portions include multiple projections extending inwards, into the interior portion of the channel. The grommet is flexible to expand along these intruding portions, due to force exerted by the wires passing through the channel. A second portion of the grommet is mounted over the surface of the interface that faces the source side compartment. The second portion has a tubular member connected to it. The tubular member has a first end projecting towards the source side compartment, and a second end that communicates with, and leads into the channel of the first portion. Further, the tubular member receives the wires from the source side compartment and delivers those wires to the receiving side compartment of the vehicle.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 show a perspective view of a dual wall grommet mountable on an interface between compartments within a vehicle, in accordance with the present disclosure.

FIG. 2 is another perspective view of the grommet of FIG. 1, showing a set of electrical connection wires passing through it.

FIG. 3 shows the grommet of FIG. 1 mounted in an interface between compartments within a vehicle, as viewed from a source side compartment.

### DETAILED DESCRIPTION OF ILLUSTRATIVE EMBODIMENTS

The following detailed description illustrates aspects of the disclosure and the ways it can be implemented. However, the description does not define or limit the invention, such definition or limitation being solely contained in the claims appended thereto. Although the best mode of carrying out the invention has been disclosed, those in the art would recognize that other embodiments for carrying out or practicing the invention are also possible.

Grommets are generally ring shaped materials made of metal, plastic or rubber, and are inserted into a hole, to prevent a cable or pipe from chafing, while passing through the hole. Generally, in a case where a set of cables/wires is desired to be passed through a hole made through a metallic surface, the wires may eventually damage due to being in contact with sharp edges of the hole. However, if a grommet is made of rubber, plastic or other suitable material, and is mounted in the hole, and used for the passage of such wires through it, it may substantially reduce deterioration of the wires' surfaces due to the smooth or soft inner surface of the grommet. The grommets used in automotive vehicles are generally designed to be water-proof, and provide a safe route for running power cables from the vehicle's interior to the engine compartment. Further, such grommets are also sealed at their entry ports to prevent noise from the engine compartment from entering the cabin compartment of the vehicle. However, some noise may still pass through, due to difficulties in sealing the ports, especially in cases where the grommet is mounted on a sheet metal surface. Also, during the process of servicing the vehicle, the grommets may need to be cut, to access the interior of the engine compartment.

The present disclosure provides a dual wall grommet configured to be mounted in a dashboard of a vehicle, and used for passage of wires from the cabin compartment to the engine compartment of the vehicle. The wires may belong to vehicle's steering system, audio system, braking system, etc.

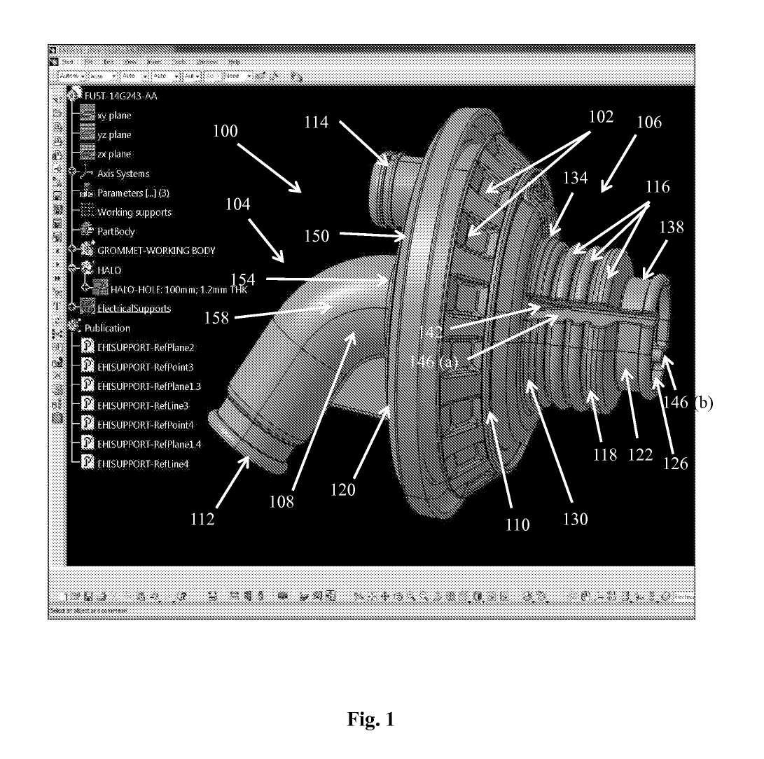

FIG. 1 shows a perspective view of a grommet configured to be mounted in an interface within a vehicle, separating a source side compartment from a receiving side compartment of the vehicle, according to the present disclosure. The source side compartment is the engine compartment of the vehicle, accommodating the engine components, the transmission, the battery, etc. The receiving side compartment is the cabin compartment of the vehicle (i.e., the compartment for the occupants of the vehicle). The interface separating the source side compartment from the receiving side compartment may be a front dashboard of the vehicle, or an interface proximal to the steering wheel, the audio system of the vehicle, the steering gear box of the vehicle, etc.

As shown, a grommet 100 separates a source side 104 from a receiving side 106. The grommet has a first portion 110 that is mounted in a surface of the interface (not shown) facing the receiving side 106. The first portion 110 has a channel 118 connected to it. The channel 118 has a substantially circular cross-section, and is hollow along its interior portion, to allow passage of wires through it. Though shown as being of circular cross-section, the channel 118 may also be of any other cross-section, including an elliptical, a rectangular, or an irregular cross-section, etc. The channel has a distal end 138 and a proximal end 134. The central portion of the grommet is substantially hollow to allow passage of wires through it, and the proximal end 134 directly communicates with the source side 104 through the central portion, to receive the bundle of wires from the source side. This will be shown in further detail in conjunction with other figures of the disclosure illustrated hereinafter. A distal portion 122 of the channel 118 is tapered with respect to the rest of the channel, and has a relatively lower cross-section. The distal portion 122 leads into an exit port 126, which is also the primary exit port of the grommet. The bundle of wires passing through the grommet is routed through the channel 118, and those wires emerge through the exit port 126, and are eventually delivered to the receiving side 106. At the receiving side 106, the emerging wires are connected to an appropriate module (not shown) within the interior of the cabin compartment of the vehicle, which may be, for example, the audio/music system or the steering system of the vehicle, etc.

A number of circular layers 116 of substantially equal cross-section extend partially at the outer surface of the channel 118. Further, as is apparent, these layers 116 have a cross-section larger than the cross-section of the distal portion 122. The larger cross-section of these layers easily accommodates the emerging bundle of wires, and absorbs the force applied by the wires, when the wires bend/flex at the exit 130 of the central portion of the grommet. Though the layers 116 are depicted as being of circular cross-section, they may also have any other appropriate shape, including an irregular shape.

The channel 118 is made of a resilient material, to facilitate its expansion in response to pressure of the bundle of wires passing through it. In a preferred embodiment, the channel 118 is composed of synthetic rubber, such as Ethylene Propylene Diene Monomer (EPDM), or Isoprene. However, other appropriate materials may also be used including natural rubber, neoprene, and so on. Also, the material of composition of the channel 118 gives it a pliable property, and therefore, it can be bent in different directions when the bundle of wires passes through it.

Multiple intruding portions 142 are provided over the outer surface of the channel 118. These intruding portions exist on both sides, diagonally oppositely, over the peripheral surface of the channel 118. Specifically, the intruding portion 142 is made of projection pairs, where each projection pair includes a first projection 146 (a) and a second projection 146 (b) (shown partially hidden) provided diagonally oppositely on the other side of the peripheral surface of the channel 118. Each of these projections 146 (a) and 146 (b) extends inwards, into the interior hollow portion of the channel 118. The purpose of these projections is to create space for the expansion of the channel 118 along the intruding portions 142, when the passing bundle of wires exerts a force on the outer surface of the channel 118. Further, the projections 146 (a) and 146 (b) are V-shaped, and intrude into the channel 118 to a pre-determined depth. Alternatively shaped projections may also be provided, to constitute these projection pairs on the intruding portions 142.

Multiple cavities 102 are provided over the first portion 110 of the grommet 100. Each of the cavities is rectangular in shape, and exists to a pre-determined depth within the interior of the central portion of the grommet. The depth of extension of the cavities 102 is based on certain design criteria and process limitations. These cavities further assist in expansion of the grommet due to excessive pressure of the passing wires. Also, the cavities 102 assist in taking the tooling core pin out of the grommet 100, during the process of manufacturing the grommet.

The grommet 100 also has a second portion 120, which faces the source side compartment of the vehicle, and therefore, is mounted on the surface of the interface opposite to the surface over which the first portion 110 is mounted. As aforementioned, the source side 104 is the engine compartment of the vehicle, containing the engine components, the battery, the brake system modules (i.e., brake booster, wheel brake cylinder, etc.), the transmission, etc.

The second portion 120 has a mounting surface 150, which substantially covers the hole made through the interface, through which the bundle of wires pass from the source side 104 to the receiving side 106. The size of the mounting surface 150 may depend on the aperture of the hole through the interface, and may vary. Accordingly, the shape of the mounting surface of the first portion 110, which mates and aligns with the mounting surface 150, may also vary.

A tubular member 108 is connected to the central portion of the mounting surface 150. The tubular member 108 carries the wires from the source side 104 and guides them towards the channel 118. An inlet port 112 constitutes a distal end of the tubular member 108, and is shown projecting into the source side compartment 104. A proximal end 154 of the tubular member 108 is connected directly to the central portion of the grommet, and that end communicates with, and leads into the channel 118. Specifically, the inlet port 112 receives the wires from the source side 104. The wires are then routed all the way through the interior portion of the tubular member 108. From the tubular member 108, the bundle of wires passes through the central portion of the grommet 100, crosses the hole through the interface, and is delivered into the channel 118. In a preferred embodiment, the tubular member is integrally fused to the central portion of the grommet 100, and the two constitute a consolidated body.

The tubular member 108 has a substantially arcuate portion 158, which is configured to turn the passing wires and direct the path of wires towards the channel 118. In a case where the elevation of the wires received from the source side 104 is lower than the elevation at which the grommet 100 is mounted in the interface, the arcuate portion 158 facilitates bending of the bundle of wires easily, to enable routing of the wires towards the receiving side 106. However, those in the art will understand that in certain embodiments, where the grommet is mounted at relatively lower elevations over the dashboard or any suitable interface within the interior of the cabin compartment of the vehicle, where the mounting surface of the interface substantially aligns with the source of wires' delivery, the tubular member 108 may also be substantially linear, with no such arcuate portions required.

The tubular member is composed of any suitable resilient material, including natural or synthetic rubber. Further, the composition of the tubular member provides it sufficient pliability, to allow bending of its portions in response to pressure exerted by the wires passing through it. Further, though shown as being of circular cross-section, the tubular member 108 may also be of any alternative appropriate shape, and hence, the shown shape is not intended to limit the scope of the present disclosure. The exact dimensions, including the cross-sectional area of the tubular member 108 may depend on certain constraints and process requirement, including the size and number of wires it is designed to accommodate, the cross-section of the channel 118 mating and aligning with it, and thus, may vary in different embodiments of the disclosure.

A service port 114 is provided over a region of the surface of the second portion 120 of the grommet 100. The service port 114 is normally sealed, in the mounted position of the grommet 100 over the interface. The surface of the first portion 110 of the grommet aligning with the service port 114 may be easily excised, to access the service 114 port when desired. Specifically, the grommet 100 may be cut all through its central portion, from the receiving side 106, till the end portion of the service port 114, to access the source side 104. As an example, in a case where a mechanic is intending to access the source side 104 from the receiving side 106, and needs to pass a set of secondary wires through the grommet 100, for further connections to any components within the source side 104, he just needs to carefully slit the grommet along its portion on the receiving side 106 that aligns horizontally with the service port 114. Conventionally, whenever a fault is identified in any components of the vehicle at the receiving side, a grommet carrying the wiring connections may need to be entirely cut to identify the underlying fault, and to access the source side. However, due to the presence of the service port 114 in the grommet 100 of the present disclosure, the interior of the source side 104 can be easily accessed from the receiving side 106 during the process of servicing.

In an embodiment, a second service port of the type 114 (not shown) may also be provided at the first portion 110 of the grommet. Through that second port, the grommet 100 may be slit all the way through its central portion, to access the interior service port 114, and this may easily allow passage of secondary wires through the grommet whenever desired, without cutting/damaging the entire grommet.

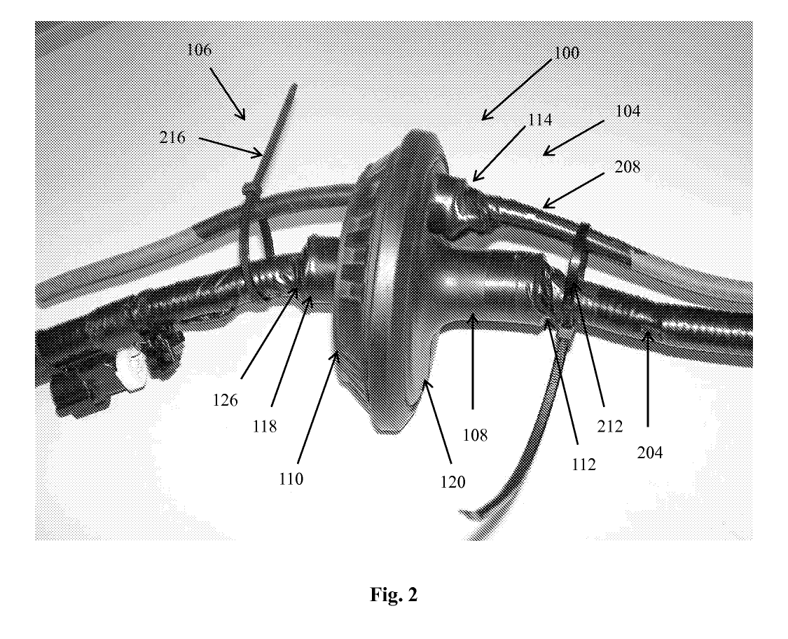

FIG. 2 shows another perspective view of the grommet 100 of FIG. 1, depicting the electrical connection wires passing through the grommet. As shown, the grommet 100 is mounted in an interface separating the source side 104 from the receiving side 106. However, the grommet 100 may also be mounted along an opposite orientation (rotated) 180° over the interface, where its first portion 110 may face the source side 104 and the second portion 120 may face the receiving side 106. A bundle constituting a primary set of wires 204 for connecting suitable components at the source side 104 to the corresponding components at the receiving side 106 passes through the central portion of the grommet 100, from the channel 118, and emerges out on the source side 104 through the tubular member 108. At the inlet port 112, where the wires 204 are received into the tubular member 108 from the source side 104, these wires are completely sealed through a tape or any other suitable sealing means. This prevents the wires 204 from being damaged, and also reduces transmission of any noise generated within the source side 104, through the grommet 100 (specifically, through the port 112), into the receiving side 106. Similarly, the wires 204 are also completely sealed at the exit port 126 of the channel 118, where they emerge and are delivered to the receiving side 106. A secondary set of wires 208, when desired, may be passed through the interior service port 114, and delivered through the grommet 100 into the receiving side 106. To achieve this secondary passage, the interior service port 114 is carefully slit to allow the passage of the wires 208. At the receiving side 106, an exterior service port may be provided (though not shown) over a section of the surface of the first portion 110 aligning with the interior access port 114. The exterior access port may also be partially slit, to receive the wires 208 passing through the interior access port 114. Once the secondary set of wires 208 is passed through the grommet, the interior service port 114 is completely sealed by an appropriate sealing means, to prevent any leakage and noise transmission through the grommet 100 towards the receiving side 106. In an embodiment, an RTV silicone sealant, or any other conventional high temperature resistant sealant may be used to avoid any leaky grommet issues. Further, before sealing the interior service port, the wires 208 are completely taped, which holds the wires intact and helps in sealing the port 114.

Assembled and mounted in the manner as noted above, the grommet 100 substantially reduces noise transmission from the source side compartment to the receiving side compartment of the vehicle. In an embodiment, when tested in the mounted position, the grommet 100 provides a transmission loss of about 70-75 decibels from the source side to the receiving side.

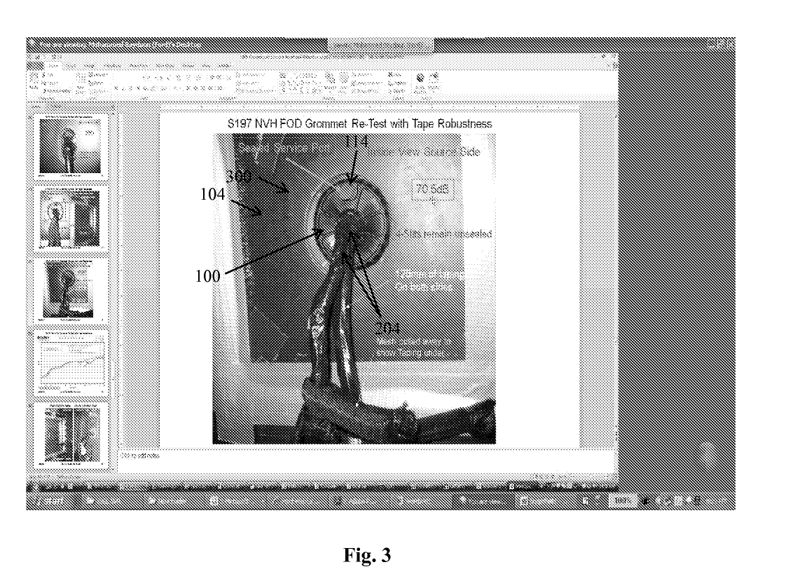

FIG. 3 shows a view of the grommet 100 in a mounted position, as seen from the source side 104. Mounted in the interface 300, the grommet receives the wires 204 and eventually delivers them to the receiving side (not shown). The service port 114 is currently shown being completely sealed, and can be slit to access the receiving side, for delivering a set of secondary wires to the receiving side when desired, as mentioned earlier.

The grommet of the present disclosure is substantially leak proof, and substantially reduces transmission of any sound waves generated on the source side compartment, to the receiving side compartment of a vehicle. Further, composition of the material of the grommet prevents the wires passing through it from damaging, and prevents them from contaminating due to dirt, air or water. In a preferred embodiment, the entire grommet may be composed of EPDM rubber. However, any other form of synthetic rubber, including neoprene, isoprene, or natural rubber, may also be used to manufacture the grommet. Any suitable conventional means may be employed to manufacture the grommet, including injection molding.

Though the grommet of the present disclosure is described and illustrated as being a dashboard grommet, configured to be mounted on an interface separating the engine compartment from the cabin compartment of a vehicle, it may find its application in other environments where it may also be mounted on any interface separating a source side compartment from a receiving compartment, to reduce noise transmission from the source side to the receiving side. Also, being more suitable for luxurious cars having their interior cabin compartments designed to meet certain standard NVH characteristics, the grommet may also be used in any other vehicles, including SUVs, trucks, etc.

Although the current invention has been described comprehensively, in considerable details to cover the possible aspects and embodiments, those skilled in the art would recognize that other versions of the invention are also possible.

What is claimed is:

1. A grommet adapted to be mountable in an opening through an interface, the interface being positioned between, and separating, a source side compartment from a receiving side compartment, the grommet comprising:
a first portion mounted over the surface of the interface facing the receiving side compartment, the first portion having a hollow channel projecting towards the receiving side compartment, and being configured to deliver a bunch of wires to the receiving side compartment, the channel having a first end, and a second end communicating with the source side compartment, the channel further having a plurality of intruding portions on its outer surface;
a second portion mounted over the surface of the interface facing a source side compartment, the second portion having a tubular member connected thereto, the tubular member having a first end projecting towards the source side compartment, and a second end communicating with, and leading into the channel of the first portion, the tubular member being configured to receive the bunch of wires from the source side compartment, and to deliver the bunch to the receiving side compartment.

2. The grommet of claim 1, wherein the tubular member connected to the second portion is composed of a pliable material.

3. The grommet of claim 1, wherein the tubular member has a substantially arcuate portion configured to direct the bunch of wires towards the channel of the first portion.

4. The grommet of claim 1, wherein the intruding portions on the outer surface of the channel include projection pairs, each projection pair having projections intruding oppositely into the interior portion of the channel.

5. The grommet of claim 4, wherein the channel is composed of a resilient material, and is configured to expand along the intruding portions, at least in response to a pressure of the bunch of wires passing through the channel.

6. The grommet of claim 5, wherein the resilient material is synthetic rubber.

7. The grommet of claim 1, and being hermetically sealed at the first end of the channel, and at the second end of the tubular member communicating with the channel.

8. The grommet of claim 1, and having a service port, the service port having portions configured to be excised, to facilitate passage of wires through it and to facilitate access to the source side compartment through it.

9. The grommet of claim 10, wherein excising the grommet along the service port is configured to create an interior access port leading into the source side compartment, and an exterior access port leading into the receiving side compartment, to facilitate passage of wires from the exterior access port to the interior access port.

10. A grommet mountable on an opening through an interface within a vehicle, the interface being positioned between, and separating a source side compartment from a receiving side compartment of the vehicle, the grommet comprising:
a first portion mounted over the surface of the interface facing the receiving side compartment, the first portion having a hollow channel projecting towards the receiving side compartment, and being configured to deliver a bunch of wires to the receiving side compartment, the channel having a first end, and a second end communicating with the source side compartment;
a second portion mounted over the surface of the interface facing a source side compartment, the second portion having a pliable tubular member, the tubular member having a first end projecting towards the source side compartment, and a second end communicating with, and leading into the channel of the first portion, the tubular member being configured to receive the bunch of wires from the source side compartment, and to deliver the bunch to the receiving side compartment.

11. The grommet of claim 10, wherein the source side compartment is the engine compartment of the vehicle, and the receiving side compartment is a cabin compartment of the vehicle.

12. The grommet of claim 10, wherein the channel of the grommet's first portion has a plurality of projection pairs provided on its outer surface, each projection pair having projections extending towards the interior portion of the channel, the projections being configured to expand outwards in response to the pressure of the bunch of wires passing through the channel.

13. The grommet of claim 12, wherein the channel of the grommet is formed of a resilient material, to facilitate expansion of the projections in response to the pressure of the bunch of wires passing through the channel.

14. The grommet of claim 13, wherein the resilient material is one of synthetic rubber and natural rubber.

15. The grommet of claim 10, wherein the pliable tubular member has an arcuate portion adapted to direct the bunch of wires from the source side compartment to the receiving side compartment.

16. The grommet of claim 10, further comprising a service port sealed service port, configured to be excised to facilitate passage of wires through it, and to facilitate access of the source side compartment through the receiving side compartment.

17. The grommet of claim 10, being configured to be positioned and mounted in a dashboard of the vehicle, proximate the steering wheel of the vehicle.

18. The grommet of claim 10, being hermetically sealed at the first end of the channel, and at the second end of the tubular member communicating with the channel.
